(19) United States
(12) Patent Application Publication
(10) Pub. No.: US 2010/0095236 A1
(43) Pub. Date: Apr. 15, 2010

(54) METHODS AND APPARATUS FOR AUTOMATED AESTHETIC TRANSITIONING BETWEEN SCENE GRAPHS

(76) Inventors: Ralph Andrew Silberstein, Grass Valley, CA (US); David Sahuc, Grass Valley, CA (US); Donald Johnson Childers, Grass Valley, CA (US)

Correspondence Address: Robert D. Shedd, Patent Operations;THOMSON Licensing LLC, P.O. Box 5312, Princeton, NJ, 08543-5312, US

(21) Appl. No.: 12/450,174

(22) PCT Filed: Jun. 25, 2007
(86) PCT No.: PCT/US2007/014753

§ 371 Date: Sep. 14, 2009

Related U.S. Application Data
(60) Provisional application No. 60/918,265, filed on Mar. 15, 2007.

(51) Int. Cl. G06F 3/048; G06T 11/20

(52) U.S. Cl. 715/781; 345/440

(57) ABSTRACT

There are provided methods and apparatus for automated aesthetic transitioning between scene graphs. An apparatus for transitioning from at least one active viewpoint in a first scene graph to at least one active viewpoint in a second scene graph includes an object state determination device, an object matcher, a transition calculator, and a transition organizer. The object state determination device is for determining respective states of the objects in the at least one active viewpoint in the first and the second scene graphs. The object matcher is for identifying matching ones of the objects between the at least one active viewpoint in the first and the second scene graphs. The transition calculator is for calculating transitions for the matching ones of the objects. The transition organizer is for organizing the transitions into a timeline for execution.

### CROSS-REFERENCE TO RELATED APPLICATIONS

This application claims priority under 35 U.S.C. 119(e) to U.S. Provisional Patent Application Ser. No. 60/918,265, filed Mar. 15, 2007, the teachings of which are incorporated herein.

### TECHNICAL FIELD

The present principles relate generally to scene graphs and, more particularly, to aesthetic transitioning between scene graphs.

### BACKGROUND

In the current switcher domain, when switching between effects, the Technical Director either manually presets the beginning of the second effect to match with the end of the first effect, or performs an automated transitioning.

However, currently available automated transition techniques are constrained to a limited set of parameters for transitioning, which are guaranteed to be present for the transition. As such, it can apply to scenes having the same structural elements which are in different states. However, a scene graph has, by nature, a dynamic structure and set of parameters.

One possible solution to solve the transition problem would be to render both scene graphs and perform a mix or wipe transition to the renderings results. However, this technique requires the capability to render the 2 scene graphs simultaneously and is usually not aesthetically pleasing since there usually are temporal and/or geometrical discontinuities in the result.

### SUMMARY

These and other drawbacks and disadvantages of the prior art are addressed by the present principles, which are directed to methods and apparatus for automated aesthetic transitioning between scene graphs.

According to an aspect of the present principles, there is provided an apparatus for transitioning from at least one active viewpoint in a first scene graph to at least one active viewpoint in a second scene graph. The apparatus includes an object state determination device, an object matcher, a transition calculator, and a transition organizer. The object state determination device is for determining respective states of the objects in the at least one active viewpoint in the first and the second scene graphs. The object matcher is for identifying matching ones of the objects between the at least one active viewpoint in the first and the second scene graphs. The transition calculator is for calculating transitions for the matching ones of the objects. The transition organizer is for organizing the transitions into a timeline for execution.

According to another aspect of the present principles, there is provided a method for transitioning from at least one active viewpoint in a first scene graph to at least one active viewpoint in a second scene graph. The method includes determining respective states of the objects in the at least one active viewpoint in the first and the second scene graphs, and identifying matching ones of the objects between the at least one active viewpoint in the first and the second scene graphs. The method further includes calculating transitions for the matching ones of the objects, organizing the transitions into a timeline for execution.

According to yet another aspect of the present principles, there is provided an apparatus for transitioning from at least one active viewpoint in a first portion of a scene graph to at least one active viewpoint in a second portion of the scene graph. The method includes an object state determination device, an object matcher, a transition calculator, and a transition organizer. The object state determination device is for determining respective states of the objects in the at least one active viewpoint in the first and the second portions. The object matcher is for identifying matching ones of the objects between the at least one active viewpoint in the first and the second portions. The transition calculator is for calculating transitions for the matching ones of the objects. The transition organizer is for organizing the transitions into a timeline for execution.

According to a further aspect of the present principles, there is provided a method for transitioning from at least one active viewpoint in a first portion of a scene graph to at least one active viewpoint in a second portion of the scene graph. The method includes determining respective states of the objects in the at least one active viewpoint in the first and the second portions, and identifying matching ones of the objects between the at least one active viewpoint in the first and the second portions. The method further includes calculating transitions for the matching ones of the objects, and organizing the transitions into a timeline for execution.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram of an exemplary sequential processing technique for aesthetic transitioning between scene graphs, in accordance with an embodiment of the present principles;

FIG. 2 is a block diagram of an exemplary parallel processing technique for aesthetic transitioning between scene graphs, in accordance with an embodiment of the present principles;

FIG. 3a is a flow diagram of an exemplary object matching retrieval technique, in accordance with an embodiment of the present principles;

FIG. 3b is a flow diagram of another exemplary object matching retrieval technique, in accordance with an embodiment of the present principles;

FIG. 4 is a sequence timing diagram for executing the techniques of the present principles, in accordance with an embodiment of the present principles;

FIG. 5A is an exemplary diagrammatic representation of an example of steps 102 and 202 of FIGS. 1 and 2, respectively, in accordance with an embodiment of the present principles;

FIG. 5B is an exemplary diagrammatic representation of an example of steps 104 and 204 of FIGS. 1 and 2, respectively, in accordance with an embodiment of the present principles;

FIG. 5C is an exemplary diagrammatic representation of steps 108 and 110 of FIG. 1 and steps 208 and 210 of FIG. 2, in accordance with an embodiment of the present principles;

FIG. 5D is an exemplary diagrammatic representation of steps 112, 114, and 116 of FIG. 1 and steps 212, 214, and 216 of FIG. 2, in accordance with an embodiment of the present principles;

FIG. 5E is an exemplary diagrammatic representation of an example at a specific point in time during the executing of the techniques of the present principles, in accordance with an embodiment of the present principles; and

FIG. 6 is a block diagram of an exemplary apparatus capable of performing automated transitioning between scene graphs, in accordance with an embodiment of the present principles.

### DETAILED DESCRIPTION

The present principles are directed to methods and apparatus for automated aesthetic transitioning between scene graphs.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As noted above, the present principles are directed to a method and apparatus for automated aesthetic transitioning between scene graphs. Advantageously, the present principles can be applied to scenes composed of different elements. Moreover, the present principles advantageously provide improved aesthetic visual rendering, which is continuous in terms of time and displayed elements, as compared to the prior art.

Where applicable, interpolation may be performed in accordance with one or more embodiments of the present principles. Such interpolation may be performed as is readily determined by one of ordinary skill in this and related arts, while maintaining the spirit of the present principles. For example, interpolation techniques are applied in one or more current switcher domain approaches involving transitioning may be used in accordance with the teachings of the present principles provided herein.

As used herein, the term “aesthetic” denotes the rendering of transitions without visual glitches. Such visual glitches include, but are not limited to, geometrical and/or temporal glitches, object total or partial disappearance, object position inconsistencies, and so forth.

Moreover, as used herein, the term “effect” denotes combined or uncombined modifications of visual elements. In the movie or television industries, the term “effect” is usually preceded by the term “visual”, hence “visual effects”. Further, such effects are typically described by a timeline (or scenario) with key frames. Those key frames define values for the modifications on the effects.

Further, as used herein, the term “transition” denotes a switch of contexts, in particular between two (2) effects. In the television industry, “transition” usually denotes switching channels (e.g., program and preview). In accordance with one or more embodiments of the present principles, a “transition” is itself an effect since it also involves modification of visual elements between two (2) effects.

Scene graphs (SGs) are widely used in any graphics (2D and/or 3D) rendering. Such rendering may involve, but is not limited to, visual effects, video games, virtual worlds, character generation, animation, and so forth. A scene graph describes the elements included in the scene. Such elements are usually referred to as “nodes” (or elements or objects), which possess parameters, usually referred to as “fields” (or properties or parameters). A scene graph is usually a hierarchical data structure in the graphics domain. Several scene graph standards exist, for example, Virtual Reality Markup Language (VRML), X3D, COLLADA, and so forth. In an extension, other Standard Generalized Markup Language (SGML) languages such as, for example, Hyper Text Markup Language (HTML) or eXtensible Markup Language (XML) based schemes can be called graphs.

Scene graph elements are displayed using a rendering engine which interprets their properties. This can involve some computations (e.g., matrices for positioning) and the execution of some events (e.g., internal animations).

It is to be appreciated that, given the teaching of the present principles provided herein, the present principles may be applied on any type of graphics including visual graphs such as, but not limited to, for example, HTML (interpolation in this case can be characters repositioning or morphing).

When developing scenes, whatever the context is, the scene(s) transitions or effects are constrained to utilizing the same structure for consistency issues. Such consistency issues include, for example, naming conflicts, objects collisions, and so forth. When several distinct scenes and, thus, scene graphs, exist in a system implementation (e.g., to provide two or more visual channels) or for editing reasons, it is then complicated to transition between the distinct scenes and corresponding scene graphs, since the visual appearance of objects differs in the scenes depending on their physical parameters (e.g., geometry, color, and so forth), position, orientation and the current active camera/viewpoint parameters. Each of the scene graphs can additionally define distinct effects if animations are already defined for them. In that case, they both possess their own timeline, but then the transition from one scene graph to another scene graph may need to be defined (e.g., for channel switching).

The present principles propose new techniques, which can be automated, to create such transition effects by computing their timeline key frames. The present principles can apply to either two separate scene graphs or two separate sections of a single scene graph.

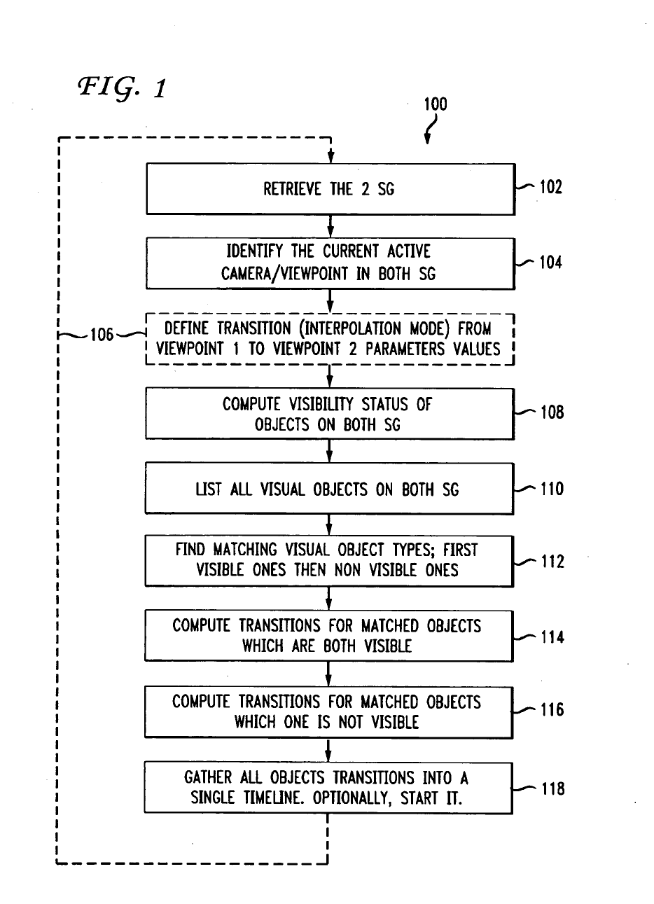

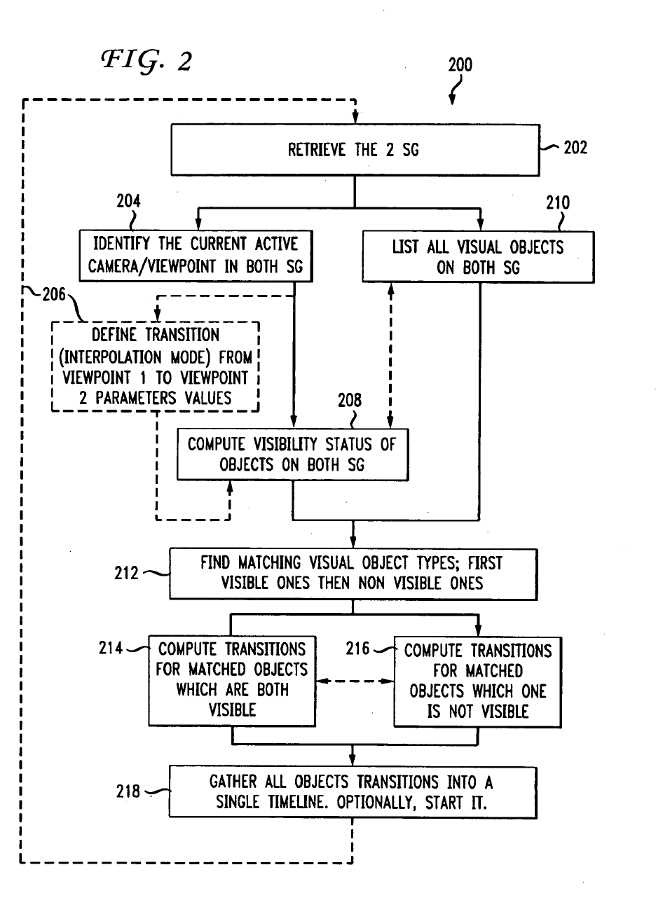

FIGS. 1 and 2 show two different implementations of the present principles, with both capable of each achieving the same result. Turning to FIG. 1, an exemplary sequential processing technique for aesthetic transitioning between scene graphs is indicated generally by the reference numeral 100. Turning to FIG. 2, an exemplary parallel processing technique for aesthetic transitioning between scene graphs is indicated generally by the reference numeral 200. Those of ordinary skill in this and related arts will appreciated that the choice between these two implementations depends on the executing platform capabilities, since some systems can embed several processing units.

In the FIGURES, we take into account the existence of two scene graphs (or two subparts of a single scene graph). In some of the following examples, the following acronyms may be employed, SG1 denotes the scene graph from which we want to transit from and SG2 denotes the scene graph to which the transition ends.

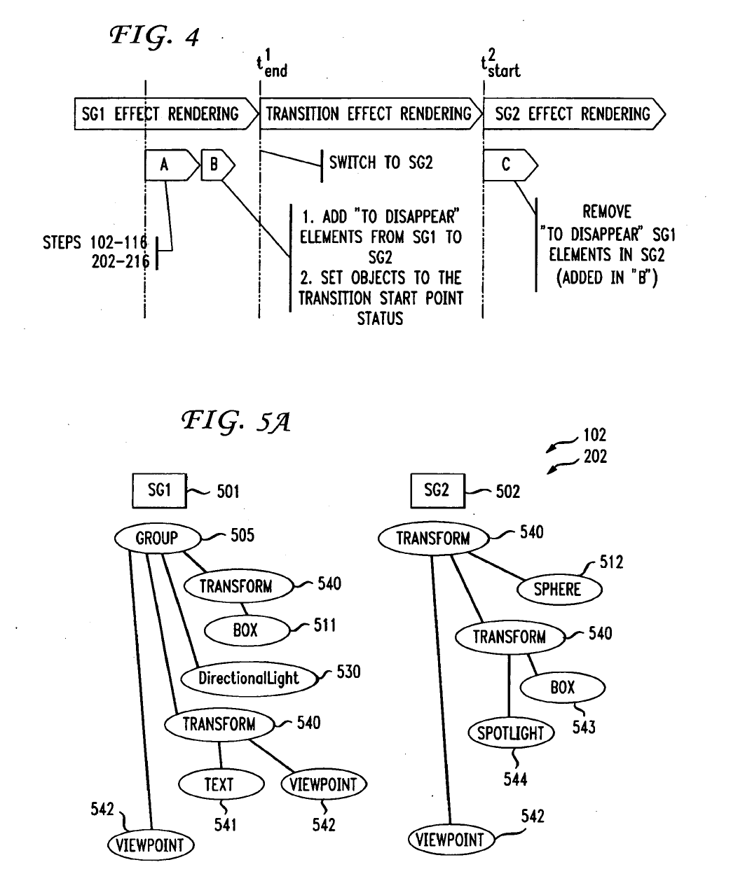

The state of the two scene graphs does not matter for the transition. If some non-looping animations or effects are already defined for either of the scene graphs, the starting state for the transition timeline can be the end of the effect(s) timeline(s) on SG1 and the timeline ending state for the transition can be the beginning of the effect(s) timeline(s) of SG2 (see FIG. 4 for an exemplary sequence diagram). However, the starting and ending transition points can be set to different states in SG1 and SG2. The exemplary processes described apply for a fixed state of both SG1 and SG2.

In accordance with two embodiments of the present principles, as shown in FIGS. 1 and 2, two separate scene graphs or two branches of the same scene graph are utilized for the processing. The method of the present principles starts at the root of the scene graph trees.

Initially, two separate scene graphs (SGs) or two branches of the same SG are utilized for the processing. The methods start at the root of the respective scene graph's trees. As shown in FIGS. 1 and 2, this is indicated by retrieving the two SGs (steps 102, 202). For each SG, we identify the active camera/viewpoint (104, 204), at a given state. Each SG can have several viewpoints/cameras defined, but only one is usually active for each of them, unless the application supports more. In the case of a single scene graph, there could be a single camera selected for the process. As an example, the camera/viewpoint for SG1 is the active one at the end of SG1 effect(s) (e.g., t¹_{end} in FIG. 4), if any. The camera/viewpoint for SG2 is the one at the beginning of SG2 effect(s) (e.g., t²ₛₜₐᵣₜ in FIG. 4), if any.

Generally speaking, it is not advised to perform (i.e., define) a transition (step 106/206) between the cameras/viewpoints identified in steps 104, 204, since it is then necessary to take into account the modification of the frustum at each new rendered frame which, thus, implies that the whole process is to be recursively applied for each frustum modification, since the visibility of the respective objects will change. While this would be intensive on processor consumption, such an approach is a possibility that may be utilized. This feature implies to cycle all the process steps for each rendered frame instead of once for the whole computed transition, taking into account the frustum modifications. Those modifications are consequences of camera/viewpoint settings including, but not limited to, for example, location, orientation, focal length, and so forth.

Next, we compute the visibility status of all visual objects on both scene graphs (108, 208). Here, the term “visual object” refers to any object that has a physical rendering attribute. A physical rendering attribute may include, but is not limited to, for example, geometries, lights, and so forth. While all structural elements (e.g., grouping nodes) are not required to match, such structural elements and the corresponding matching are taken into account for the computation of the visibility status of the visual objects. This process computes the elements visible in the frustum of the active camera of SG1 at the end of its timeline and the visible elements in the frustum of the active camera of SG2 at the beginning of the SG2 timeline. In one implementation, computation of visibility shall be performed through occlusion culling methods.

All the visual objects on both scene graphs are then listed (110, 210). Those of skill in the art will recognize that this could be performed during steps 106,206. However, in certain implementations, since the system can embed several processing units, the two tasks may be performed separately, i.e., in parallel. Relevant visual and geometrical objects are usually leaves or terminal branches (e.g., for composed objects) in a scene graph tree.

Using outputs of steps 108 and 110 or outputs of steps 209 and 210 (depending upon which process is used between FIG. 1 and FIG. 2), we retrieve or find the matching elements on both SGs (112, 212). In an embodiment, one particular implementation, the system would: (1) match visible elements on both SGs first; (2) then match the remaining visible elements in SG2 to non-visible elements in SG1; and (3) then match the remaining visible elements on SG1 to non-visible elements on SG2. At the end of this step, all visible elements of SG1 which have not found a match will be flagged as “to disappear” and all visible elements of SG2 which have not found a match will be flagged as “to appear”. All non-matching non-visible elements can be left untouched or flagged “non-visible”.

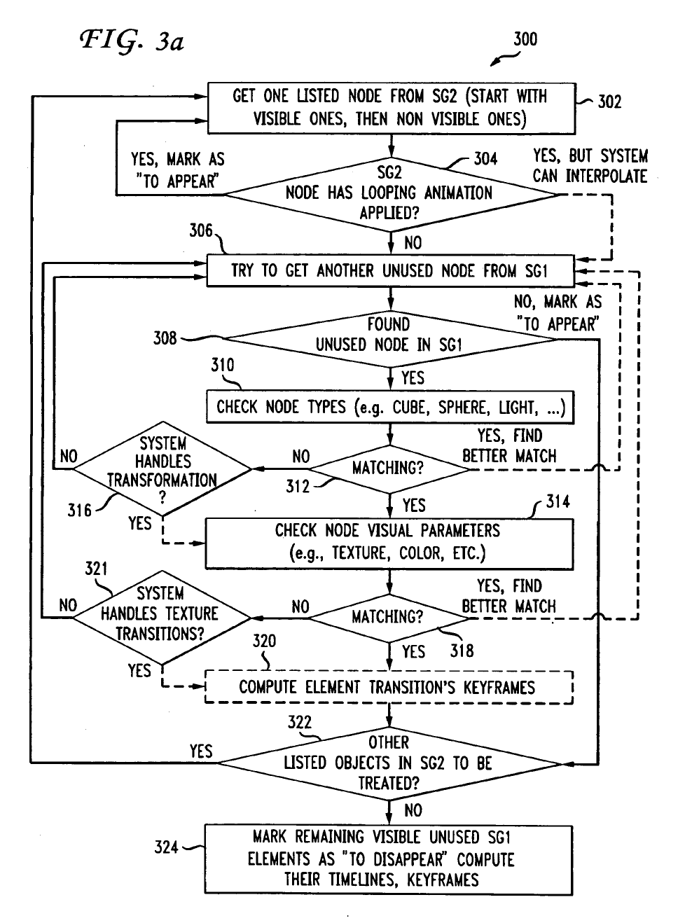

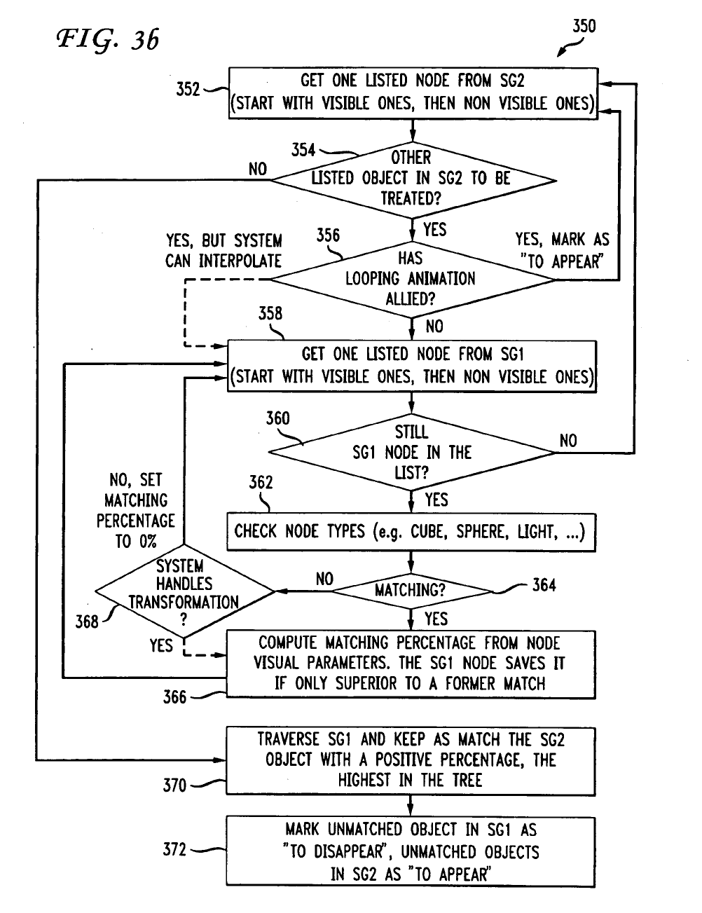

Turning to FIG. 3A, an exemplary object matching retrieval method is indicated generally by the reference numeral 300.

One listed node is obtained from SG2 (start with visible nodes, then non-visible nodes) (step 302). It is then determined whether the SG2 node has a looping animation applied (step 304). If so the system can interpolate and, in any event, we try to obtain a node from SG1's list of nodes (start with visible nodes, then non-visible nodes) (step 306). It is then determined whether or not a node is still unused in the SG1's list of nodes (step 308). If so, then check node types (e.g., cube, sphere, light, and so forth) (step 310). Otherwise, control is passed to step 322.

It is then determined whether or not there is a match (step 312). If so, node visual parameters (e.g., texture, color, and so forth) are checked (step 314). Also, if so, control may instead be optionally returned to step 306 to find a better match. Otherwise, it is then determined whether or not the system handles transformation. If so, then control is passed to step 314. Otherwise, control is returned to step 306.

From step 314, it is then determined whether or not there is a match (step 318). If so, then element transition's key frames are computed (step 320). Also, if so, control may instead be optionally returned to step 306 to find a better match. Otherwise, it is then determined whether or not the system handles texture transitions (step 321). If so, then control is passed to step 320. Otherwise, control is returned to step 306.

From step 320, it is then determined whether or not other listed objects in SG2 are to be treated (step 322). If so, then control is returned to step 302. Otherwise, mark the remaining visible unused SG1 elements as “to disappear”, and compute their timelines' key frames (step 324).

The method 300 allows for the retrieval of matching elements in two scene graphs. The Iteration starting point, of either SG1 or SG2 nodes, does not matter. However, for illustrative purposes, the starting point shall be SG2 nodes, since SG1 could be currently used for rendering, while the transition process could start in parallel as shown in FIG. 3B. If the system possesses more than one processing unit, some of the actions can be processed in parallel. It is to be appreciated that the timeline computations, respectively shown as steps 118, 218 in FIGS. 1 and 2, respectively, are optional steps since they can be performed either in parallel or after all matching is performed.

It is to be appreciated that the present principles do not impose any restrictions on the matching criteria. That is, the selection of the matching criteria is advantageously left up to the implementer. Nonetheless, for purposes of illustration and clarity, various matching criteria are described herein.

In one embodiment, the matching of objects can be performed by a simple node type (steps 310, 362) and parameters checking (e.g., 2 cubes) (steps 314, 366). In other embodiments, we may further evaluate the nodes semantic, e.g. at the geometry level (e.g. triangles or vertices composing the geometry) or at the character level for a text. The latter embodiments may use decomposition of the geometries, which would allow character displacements (e.g., characters reordering) and morphing transition (e.g., morphing a cube into a sphere or a character into another). However, it is preferable, as show in FIGS. 3A and 3B, to select this lower semantic analysis as an option, only if some objects have not found a simple matching criterion.

It is to be appreciated that textures used for the geometries can be a criterion for the matching of objects. It is to be further appreciated that the present principles do not impose any restrictions on the textures. That is, the selection of textures and textures characteristics for the matching criteria is advantageously left up to the implementer. This criterion needs an analysis or the texture address used for the geometries, possibly a standard uniform resource locator (URL). If the scene graph rendering engine of a particular implementation has the capabilities to apply some multi-texturing with some blending, interpolation of the textures pixels can be performed.

If existing in either of the two SGs, internal looping animations applying to their objects can be a criterion for the matching (steps 304, 356), since it can be complex to combine those internal interpolations to the ones to be applied for the transition. Thus, it is preferable that the combination be used, when the implementation can support the combination.

Some exemplary criteria for matching objects include, but are not limited to: visibility; name; node and/or element and/or object type; texture; and loop animation.

For example, regarding the use of visibility as a matching criterion, it is preferable to first match visible objects on both scene graphs.

Regarding the use of name as a matching criterion, it is possible, but not too likely, that some elements in both scene graphs may have the same name since they are the same element. This parameter could however give a tip on the matching.

Regarding the use of node and/or element and/or object type as matching criteria, an object type may include, but is not limited to, a cube, light, and so forth. Moreover, textual elements can discard a match (e.g., “Hello” and “Olla”), unless the system can perform such semantic transformations. Further, specific parameters or properties or field values can discard a match (e.g., a spot light versus a directional light), unless the system can perform such semantic transformations. Also, some types might not need matching (e.g., cameras/viewpoints other than the active one). Those elements will be discarded during transition and just added or removed as the transition starts or ends.

Regarding the use of texture as a matching criterion, texture may be used for the node and/or element and/or object or discard a match if the system doesn't support texture transitions.

Regarding the use of looping animation as a matching criterion, such looping animation may discard a match if applied to an element and/or node and/or object on a system which does not support looping animation transitioning.

In an embodiment, each object may define a matching function (e.g., ‘==’ operator in C++ or ‘equals ( )’ function in Java) to perform a self-analysis.

Even if a match is found early in the process for an object, a better match (steps 318, 364) could be found (e.g., better object parameters matching or closer location).

Turning to FIG. 3B, another exemplary object matching retrieval method is indicated generally by the reference numeral 350. The method 350 of FIG. 3B is more advanced than the method 300 of FIG. 3A and, in most cases, provides better results and solves the “better matching” issue but at more computational cost.

One listed node is obtained from SG2 (start with visible nodes, then non-visible nodes) (step 352). It is then determined whether or not any other listed object in SG2 is to be treated (step 354). If not, then control is passed to step 370. Otherwise, if so, it is then determined whether the SG2 node has a looping animation applied (step 356). If so, then mark as “to appear” and control is returned to step 352. Also, if so, then system can interpolate and, in any event, one listed node is obtained from SG1 (start with visible nodes, then non-visible nodes) (step 358). It is then determined whether or not there is still a SG1 node in the list (step 360). If so, then check node types (e.g., cube, sphere, light, and so forth) (step 362). Otherwise, control is passed to step 352.

It is then determined whether or not there is a match (step 364). If so, compute the matching percentage from the node visual parameters, and have the SG1 save the matching percentage only if the currently calculated matching percentage is superior to a former calculated matching percentage (step 366). Otherwise, it is then determined whether or not the system handles transformation. If so, then control is passed to step 366. Otherwise, control is returned to step 358.

At step 370, traverse SG1 and keep as a match the SG2 object with a positive percentage, such as the highest in the tree. Mark unmatched objects in SG1 as “to disappear” and unmatched objects in SG2 as “to appear” (step 372).

Thus, contrary to the method 300 of FIG. 3A which essentially uses a binary match, the method 350 of FIG. 3B uses a percentage match (366). For each object in the second SG, this technique computes a percentage match to every object in the first SG (depending on the matching parameters above). When a positive percentage is found between an object in SG2 and one in SG1, the one in SG1 only records it if the value is higher than a previously computed match percentage. When all the objects in SG2 are processed, this technique traverses (370) SG1 objects from top to bottom and keeps as match the SG2 object which matches the SG1 the highest in SG1 tree hierarchy. If there are matches under this tree level, they are discarded.

Compute transitions' key frames (step 320) for matched objects which are both visible. There are two options for transitioning from SG1 to SG2. The first option for transitioning from SG1 to SG2 is to create or modify the elements from SG2 flagged “to appear” into SG1, out of the frustum, have the transitions performed and then switch to SG2 (at the end of the transition, both visual results are matching). The second option for transitioning from SG1 to SG2 is to create the elements flagged as “to disappear” from SG1 into SG2, while having the “to appear” elements from SG2 out of the frustum, switch to SG2 at the beginning of the transition and perform the transition and remove the “to disappear” elements added earlier. In an embodiment, the second option is selected since the effect(s) on SG2 should be run after the transition is performed. Thus, the whole process can be running in parallel of SG1 usage (as shown in FIG. 4) and be ready as soon as possible. Some camera/viewpoint settings may be taken into account in both options, since they can differ (e.g., focal angle). Depending on the selected option, the rescaling and coordinate translations of the objects may have to be performed when adding elements from one scene graph into the other scene graph. When the feature in any of steps 106, 206 is activated, this should be performed for each rendering step.

Transitions for each element can have different interpolation parameters. Matching visible elements may use parameters transitions (e.g., repositioning, re-orientation, re-scaling, and so forth). It is to be appreciated that the present principles do not impose any restrictions on the interpolation technique. That is, the selection of which interpolation technique to apply is advantageously left up to the implementer.

Since repositioning/rescaling of objects might imply some modifications of the parent node (e.g., transformation node), the parent node of the visual object will have its own timeline as well. Since modification of the parent node might imply some modification of siblings of the visual node, in certain cases the siblings may have their own timeline. This would be applicable, for example, in the case of a transformation sibling node. This case can also be solved by either inserting a temporary transformation node which would negate the parent node modifications or more simply by transforming adequately the scene graph hierarchy to remove the transformation dependencies for the duration of the transition effect.

Compute transitions' key frames (step 320) for matched objects when one of them is not visible (i.e., is marked either as “to appear” or “to disappear”). This step can be either performed in parallel of steps 114, 214, sequentially or in the same function call. In other embodiments, both steps 114 and 116 and/or step 214 and 216 could interact with each other in the case where the implementation allows the user to select a collision mode (e.g., using an “avoid” mode to prohibit objects from intersecting with each other or using an “allow” mode to allow the intersection of objects). In some embodiments (e.g., a rendering system managing a physical engine), a third “interact” mode could be implemented to offer objects that are to interact with each other (e.g., bumping into each other).

Some exemplary parameters for setting a scene graph transition include, but are not limited to the following. It is to be appreciated that the present principles do not impose any restrictions on such parameters. That is, the selection of such parameters is advantageously left up to the implementer, subject to the capabilities of the applicable system to which the present principles are to be applied.

An exemplary parameter for setting a scene graph transition involves an automatic run. If activated, the transition will run as soon as the effect in the first scene graph has ended.

Another exemplary parameter(s) for setting a scene graph transition involves active cameras and/or viewpoints transition. The active cameras and/or viewpoints transition parameter(s) may involve an enable/disable as parameters. The active cameras and/or viewpoints transition parameter(s) may involve a mode selection as a parameter. For example, the type of transition to be performed between the two viewpoints locations, such as, “walk”, “fly”, and so forth, may be used as parameters.

Yet another exemplary parameter(s) for setting a scene graph transition involves an optional intersect mode. The intersection mode may involve, for example, the following modes during transition, as also described herein, which may be used as parameters: “allow”; “avoid”; and/or “interact”.

Moreover, other exemplary parameters for setting a scene graph transition, for visible objects that are matching in both SGs, involve textures and/or mode. With respect to textures, the following operations may be used: “Blend”; “Mix”; “Wipe”; and/or “Random”. For blending and/or mixing operations, a mixing filter parameter may be used. For a wipe operation: a pattern to be used or dissolving may be used as a parameter(s). With respect to mode, this may be used to define the type of interpolation to be used (e.g., “Linear”). Advanced modes that may be used include, but are not limited to, “Morphing”, “Character displacement”, and so forth.

Further, other exemplary parameters for setting a scene graph transition, for visible objects that are flagged “to appear” or “to disappear” in both SGs, involve appear/disappear mode, fading, fineness, and from/to locations (respectively for appearing/disappearing). With respect to appear/disappear mode, “fading” and/or “move” and/or “explode” and/or “other advanced effect” and/or “scale” or “random” (the system randomly generates the mode parameters) may be involved and/or used as parameters. With respect to fading, if a fading mode is enabled in an embodiment and selected, a transparency factor (inverted for appearing) can be used and applied between the beginning and the end of the transition. With respect to fineness, if a fineness mode is selected, such as, for example, explode, advanced, and so forth, they may be used as parameters. With respect to from/to, if selected (e.g., combined with move, explode or advanced), one of such locations may be used as a parameter. Either a “specific location” where the object goes to/arrives from (this might need to be used together with the fading parameter in case the location is defined in the camera frustum), or “random” (will generate a random location out of the target camera frustum), or “viewpoint” (the object will move toward/from the viewpoint location), or “opposite direction” (the object will move away/come towards the viewpoint orientation) may be used as parameters. Opposite direction may be used together with the fading parameter.

In an embodiment, each object should possess its own transition timeline creation function (e.g., “computeTimelineTo (Target, Parameters)” or “computeTimelineFrom (Source, Parameters)” function), since each of the objects possesses the list of parameters that need to be processed. This function would create the key frames for the object's parameters transition along with their values.

A sub-part of the parameters listed above can be used for an embodiment, but this will thus remove functionality.

Since the newly defined transition is also an effect in itself, embodiments can allow automatic transition execution by adding a “speed” or duration parameter as additional control for each parameter or the transition as a whole. The transition effect from one scene graph to another scene graph can be represented as a timeline, that begins with the derived starting key frame and ends with the derived ending key frame or these derived key frames may be represented as two key frames with the interpolation being computed on the fly in a manner similar to the “Effects Dissolve™” used in Grass Valley switchers. Thus, the existence of this parameter depends upon if the present principles are employed in a real-time context (e.g., live) or during editing (e.g., offline or post-production).

If the feature of any of step 106, 206 is selected, then the process needs to be performed for each rendering step (either field or frame). This is represented by the optional looping arrows in FIGS. 1 and 2. It is to be appreciated that some results from former loops can be reused such as, for example, the listing of visual elements in steps 110, 210.

Turning to FIG. 4, exemplary sequences for the methods of the present principles are indicated generally by the reference numeral 400. The sequences 400 correspond to the case of “live” or “broadcast” events, which have the strictest time constraints. In “edit” mode or “post-production” cases, actions can be sequenced differently. FIG. 4 illustrates that the methods of the present principles may be started in parallel of the execution of the first effect. Moreover, FIG. 4 represents the beginning and end of the computed transition respectively as the end of SG1 and beginning of SG2 effects, but those two points can be different states (at different instants) on those 2 scene graphs.

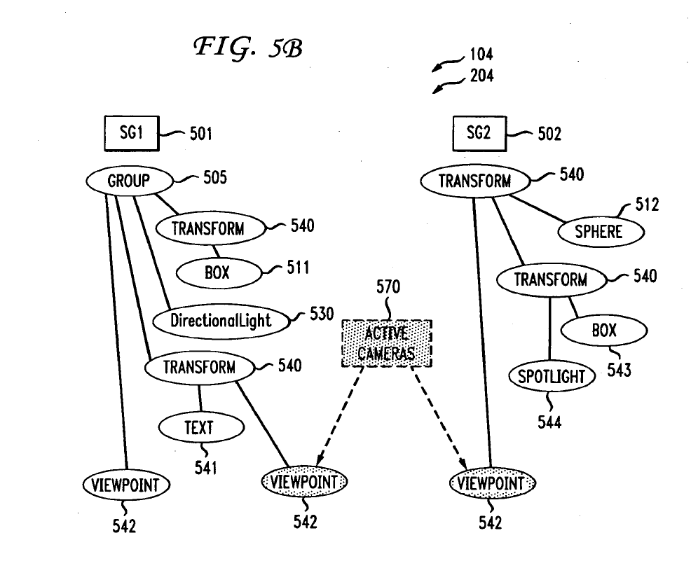

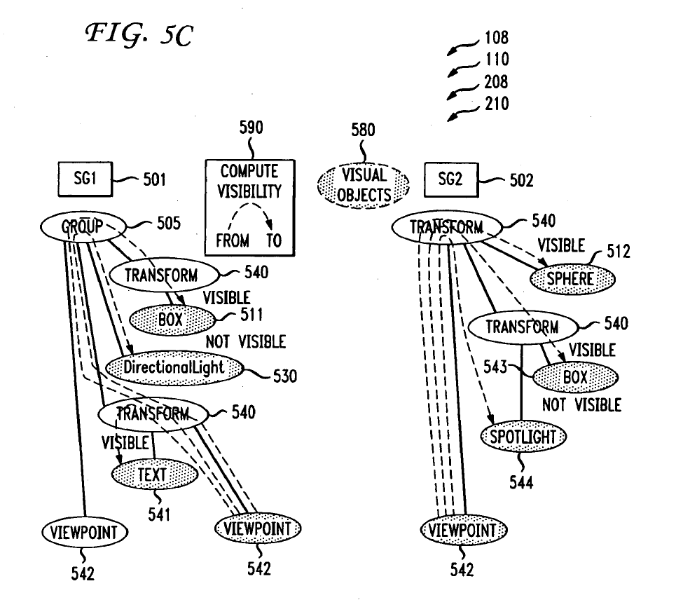

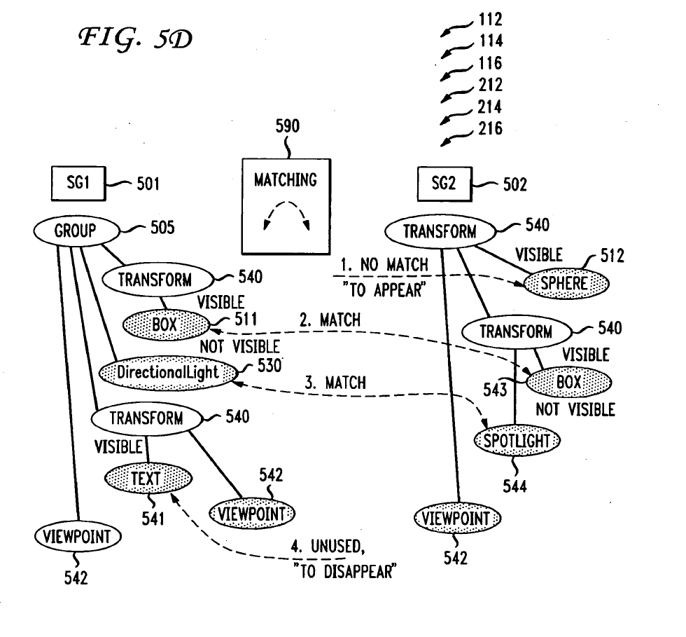

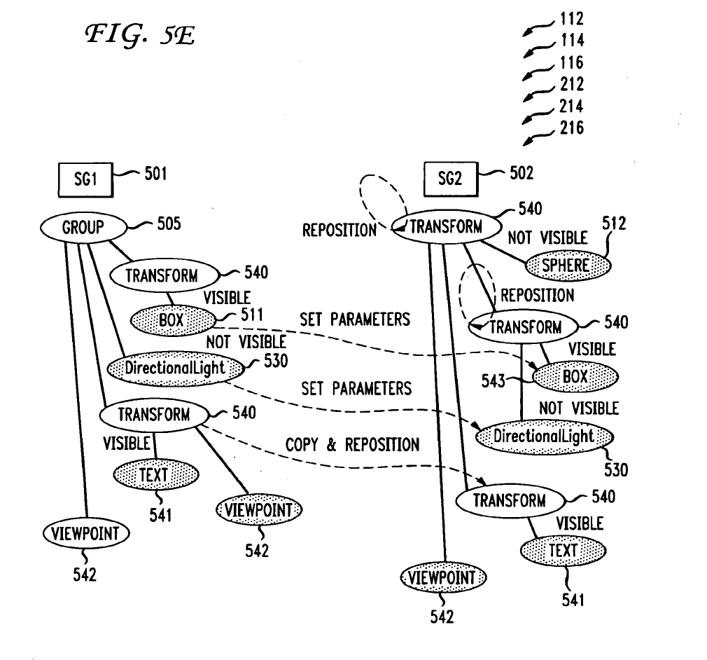

Turning to FIG. 5A, steps 102, 202 of methods 100 and 200 of FIGS. 1 and 2, respectively, are further described.

Turning to FIG. 5B, steps 104, 204 of methods 100 and 200 of FIGS. 1 and 2, respectively, are further described.

Turning to FIG. 5C, steps 108, 110 and 208, 210 of methods 100 and 200 of FIGS. 1 and 2, respectively, are further described.

Turning to FIG. 5D, steps 112, 114, 116, and 212, 214, 216 of methods 100 and 200 of FIGS. 1 and 2, respectively, are further described.

Turning to FIG. 5E, steps 112, 114, and 116, and 212, 214, and 216 of methods 100 and 200 of FIGS. 1 and 2, respectively, before or at instant t¹_{end} are further described.

FIGS. 5A-5D relates to the use of a VRML/X3D type of scene graph structure, which does not select the feature of steps 106, 206, and performs steps 108, 110, or steps 208, 210 in a single pass.

In FIGS. 5A-5E, SG1 and SG2 are denoted by the reference numerals 501 and 502, respectively. Moreover, the following reference numeral designations are used: group 505; transform 540; box 511; sphere 512; directional light 530; transform 540; text 541; viewpoint 542; box 543; spotlight 544; active cameras 570; and visual objects 580. Further, legend material is denoted generally by the reference numeral 590.

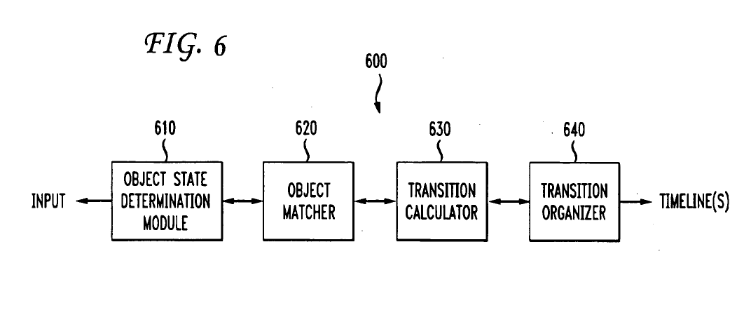

Turning to FIG. 6, an exemplary apparatus capable of performing automated transitioning between scene graphs is indicated generally by the reference numeral 600. The apparatus 600 includes an object state determination module 610, an object matcher 620, a transition calculator 630, and a transition organizer 640.

The object state determination module 610 determines respective states of the objects in the at least one active viewpoint in the first and the second scene graphs. The state of an object includes a visibility status for this object for a certain viewpoint and thus may involve computation of its transformation matrix for location, rotation, scaling, and so forth which are used during the processing of the transition. The object matcher 620 identifies matching ones of the objects between the at least one active viewpoint in the first and the second scene graphs. The transition calculator 630 calculates transitions for the matching ones of the objects. The transition organizer 640 organizes the transitions into a timeline for execution.

It is to be appreciated that while the apparatus 600 of FIG. 6 is depicted for sequential processing, one of ordinary skill in this and related arts will readily recognize that apparatus 600 may be easily modified with respect to inter element connections to allow parallel processing of at least some of the steps described herein, while maintaining the spirit of the present principles.

Moreover, it is to be appreciated that while the elements of apparatus 600 are shown as stand alone elements for the sake of illustration and clarity, in one or more embodiments, one or more functions of one or more of the elements may be combined and/or otherwise integrated with one or more of the other elements, while maintaining the spirit of the present principles. Further, given the teachings of the present principles provided herein, these and other modifications and variations of the apparatus 600 of FIG. 6 are readily contemplated by one of ordinary skill in this and related arts, while maintaining the spirit of the present principles. For example, as noted above, the elements of FIG. 6 may be implemented in hardware, software, and/or a combination thereof, while maintaining the spirit of the present principles.

It is to be further appreciated that one or more embodiments of the present principles may, for example: (1) be used either in a real-time context, e.g. live production, or not, e.g. edition, pre-production or post-production; (2) have some predefined settings as well as user preferences depending on the context in which they are used; (3) be automated when the settings or preferences are set; and/or (4) seamlessly involve basic interpolation computations as well as advanced ones, e.g. morphing, depending on the implementation choice. Of course, given the teachings of the present principles provided herein, it is to be appreciated that these and other applications, implementations, and variations may be readily ascertained by one of ordinary skill in this and related arts, while maintaining the spirit of the present principles.

Moreover, it is to be that embodiments of the present principles may be automated (versus manual embodiments also contemplated by the present principles) such as, for example, when using predefined settings. Further, embodiments of the present principles provide for aesthetic transitioning by, for example, ensuring temporal and geometrical/spatial continuity during transitions. Also, embodiments of the present principles provide a performance advantage over basic transition techniques since the matching in accordance with the present principles ensures re-use of existing elements and, thus, less memory is used and rendering time is shortened (since this time usually depends on the number of elements in transitions). Additionally, embodiments of the present principles provide flexibility versus handling static parameter sets since the present principles are capable of handling completely dynamic SG structures and, thus, can be used in different contexts (for example, including, but not limited to, games, computer graphics, live production, and so forth). Further, embodiments of the present principles are extensible as compared to predefined animations, since parameters can be manually modified, added in different embodiments, and improved depending on apparatus capabilities and computing power.

A description will now be given of some of the many attendant advantages/features of the present invention, some of which have been mentioned above. For example, one advantage/feature is an apparatus for transitioning from at least one active viewpoint in a first scene graph to at least one active viewpoint in a second scene graph. The apparatus includes an object state determination device, an object matcher, a transition calculator, and a transition organizer. The object state determination device is for determining respective states of the objects in the at least one active viewpoint in the first and the second scene graphs. The object matcher is for identifying matching ones of the objects between the at least one active viewpoint in the first and the second scene graphs. The transition calculator is for calculating transitions for the matching ones of the objects. The transition organizer is for organizing the transitions into a timeline for execution.

Another advantage/feature is the apparatus as described above, wherein the respective states represent respective visibility statuses for visual ones of the objects, the visual ones of the objects having at least one physical rendering attribute.

Yet another advantage/feature is the apparatus as described above, wherein the transition organizer organizes the transitions in parallel with at least of determining the respective states of the objects, identifying the matching ones of the objects, and calculating the transitions.

Still another advantage/feature is the apparatus as described above, wherein the object matcher identifies the matching ones of the objects using matching criteria, the matching criteria including at least one of a visibility state, an element name, an element type, an element parameter, an element semantic, an element texture, and an existence of animation.

Moreover, another advantage/feature is the apparatus as described above, wherein the object matcher uses at least one of binary matching and percentage-based matching.

Further, another advantage/feature is the apparatus as described above, wherein at least one of the matching ones of the objects has a visibility state in the at least one active viewpoint in one of the first and the second scene graphs and an invisibility state in the at least one active viewpoint in the other one of the first and the second scene graphs.

Also, another advantage/feature is the apparatus as described above, wherein the object matcher initially matches visible ones of the objects in the first and the second scene graphs, followed by remaining visible ones of the objects in the second scene graph to non-visible ones of the objects in the first scene graph, and followed by remaining visible ones of the objects in the first scene graph to non-visible ones of the objects in the second scene graph.

Additionally, another advantage/feature is the apparatus as described above, wherein the object matcher marks further remaining, non-matching visible ones of the objects in the first scene graph using a first index, marks further remaining, non-matching visible objects in the second scene graph using a second index.

Moreover, another advantage/feature is the apparatus as described above, wherein the object matcher ignores or marks remaining, non-matching non-visible ones of the objects in the first and the second scene graphs using a third index.

Further, another advantage/feature is the apparatus as described above, wherein the timeline is a single timeline for all of the matching ones of the objects.

Also, another advantage/feature is the apparatus as described above, wherein the timeline is one of a plurality of timelines, each of the plurality of timelines corresponding to a respective one of the matching ones of the objects.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus for transitioning from at least one active viewpoint in a first scene graph to at least one active viewpoint in a second scene graph, the apparatus comprising:
an object state determination device for determining respective states of the objects in the at least one active viewpoint in the first and the second scene graphs;
an object matcher for identifying matching ones of the objects between the at least one active viewpoint in the first and the second scene graphs;
a transition calculator for calculating transitions for the matching ones of the objects; and
a transition organizer for organizing the transitions into a timeline for execution.

2. The apparatus of claim 1, wherein the respective states represent respective visibility statuses for visual ones of the objects, the visual ones of the objects having at least one physical rendering attribute.

3. The apparatus of claim 1, wherein said transition organizer organizes the transitions in parallel with at least of determining the respective states of the objects, identifying the matching ones of the objects, and calculating the transitions.

4. The apparatus of claim 1, wherein said object matcher identifies the matching ones of the objects using matching criteria, the matching criteria including at least one of a visibility state, an element name, an element type, an element parameter, an element semantic, an element texture, and an existence of animation.

5. The apparatus of claim 1, wherein said object matcher uses at least one of binary matching and percentage-based matching.

6. The apparatus of claim 1, wherein at least one of the matching ones of the objects has a visibility state in the at least one active viewpoint in one of the first and the second scene graphs and an invisibility state in the at least one active viewpoint in the other one of the first and the second scene graphs.

7. The apparatus of claim 1, wherein said object matcher initially matches visible ones of the objects in the first and the second scene graphs, followed by remaining visible ones of the objects in the second scene graph to non-visible ones of the objects in the first scene graph, and followed by remaining visible ones of the objects in the first scene graph to non-visible ones of the objects in the second scene graph.

8. The apparatus of claim 7, wherein said object matcher marks further remaining, non-matching visible ones of the objects in the first scene graph using a first index, marks further remaining, non-matching visible objects in the second scene graph using a second index.

9. The apparatus of claim 8, wherein said object matcher ignores or marks remaining, non-matching non-visible ones of the objects in the first and the second scene graphs using a third index.

10. The apparatus of claim 1, wherein the timeline is a single timeline for all of the matching ones of the objects.

11. The apparatus of claim 1, wherein the timeline is one of a plurality of timelines, each of the plurality of timelines corresponding to a respective one of the matching ones of the objects.

12. A method for transitioning from at least one active viewpoint in a first scene graph to at least one active viewpoint in a second scene graph, the method comprising:
determining respective states of the objects in the at least one active viewpoint in the first and the second scene graphs;
identifying matching ones of the objects between the at least one active viewpoint in the first and the second scene graphs;
calculating transitions for the matching ones of the objects; and
organizing the transitions into a timeline for execution.

13. The method of claim 12, wherein the respective states represent respective visibility statuses for visual ones of the objects, the visual ones of the objects having at least one physical rendering attribute.

14. The method of claim 12, wherein said organizing step is performed in parallel with at least of the said determining, said identifying, and said calculating steps.

15. The method of claim 12, wherein said identifying step uses matching criteria, the matching criteria including at least one of a visibility state, an element name, an element type, an element parameter, an element semantic, an element texture, and an existence of animation.

16. The method of claim 12, wherein said identifying step using at least one of binary matching and percentage-based matching.

17. The method of claim 12, wherein at least one of the matching ones of the objects has a visibility state in the at least one active viewpoint in one of the first and the second scene graphs and an invisibility state in the at least one active viewpoint in the other one of the first and the second scene graphs.

18. The method of claim 12, wherein said identifying step comprises initially matching visible ones of the objects in the first and the second scene graphs, followed by matching remaining visible ones of the objects in the second scene graph to non-visible ones of the objects in the first scene graph, and followed by matching remaining visible ones of the objects in the first scene graph to non-visible ones of the objects in the second scene graph.

19. The method of claim 18, wherein said identifying step further comprises marking further remaining, non-matching visible ones of the objects in the first scene graph using a first index, marks further remaining, non-matching visible objects in the second scene graph using a second index.

20. The method of claim 19, wherein said identifying step further comprises ignoring or marking remaining, non-matching non-visible ones of the objects in the first and the second scene graphs using a third index.

21. The method of claim 12, wherein the timeline is a single timeline for all of the matching ones of the objects.

22. The method of claim 12, wherein the timeline is one of a plurality of timelines, each of the plurality of timelines corresponding to a respective one of the matching ones of the objects.

23. An apparatus for transitioning from at least one active viewpoint in a first portion of a scene graph to at least one active viewpoint in a second portion of the scene graph, the method comprising:
an object state determination device for determining respective states of the objects in the at least one active viewpoint in the first and the second portions;
an object matcher for identifying matching ones of the objects between the at least one active viewpoint in the first and the second portions;
a transition calculator for calculating transitions for the matching ones of the objects; and
a transition organizer for organizing the transitions into a timeline for execution.

24. The apparatus of claim 23, wherein the respective states represent respective visibility statuses for visual ones of the objects, the visual ones of the objects having at least one physical rendering attribute.

25. The apparatus of claim 23, wherein said transition organizer (640) organizes the transitions in parallel with at least of determining the respective states of the objects, identifying the matching ones of the objects, and calculating the transitions.

26. The apparatus of claim 23, wherein said object matcher identifies the matching ones of the objects using matching criteria, the matching criteria including at least one of a visibility state, an element name, an element type, an element parameter, an element semantic, an element texture, and an existence of animation.

27. The apparatus of claim 23, wherein said object matcher uses at least one of binary matching and percentage-based matching.

28. The apparatus of claim 23, wherein at least one of the matching ones of the objects has a visibility state in the at least one active viewpoint in one of the first and the second portions and an invisibility state in the at least one active viewpoint in the other one of the first and the second portions.

29. The apparatus of claim 23, wherein said object matcher initially matches visible ones of the objects in the first and the second scene graphs, followed by remaining visible ones of the objects in the second scene graph to non-visible ones of the objects in the first scene graph, and followed by remaining visible ones of the objects in the first scene graph to non-visible ones of the objects in the second scene graph.

30. The apparatus of claim 29, wherein said object matcher marks further remaining, non-matching visible ones of the objects in the first scene graph using a first index, marks further remaining, non-matching visible objects in the second scene graph using a second index.

31. The apparatus of claim 30, wherein said object matcher ignores or marks remaining, non-matching non-visible ones of the objects in the first and the second scene graphs using a third index.

32. The apparatus of claim 23, wherein the timeline is a single timeline for all of the matching ones of the objects.

33. The apparatus of claim 23, wherein the timeline is one of a plurality of timelines, each of the plurality of timelines corresponding to a respective one of the matching ones of the objects.

34. A method for transitioning from at least one active viewpoint in a first portion of a scene graph to at least one active viewpoint in a second portion of the scene graph, the method comprising:
determining respective states of the objects in the at least one active viewpoint in the first and the second portions;
identifying matching ones of the objects between the at least one active viewpoint in the first and the second portions;
calculating transitions for the matching ones of the objects; and
organizing the transitions into a timeline for execution.

35. The method of claim 34, wherein the respective states represent respective visibility statuses for visual ones of the objects, the visual ones of the objects having at least one physical rendering attribute.

36. The method of claim 34, wherein said organizing step is performed in parallel with at least of the said determining, said identifying, and said calculating steps.

37. The method of claim 34, wherein said identifying step uses matching criteria, the matching criteria including at least one of a visibility state, an element name, an element type, an element parameter, an element semantic, an element texture, and an existence of animation.

38. The method of claim 34, wherein said identifying step using at least one of binary matching and percentage-based matching.

39. The method of claim 34, wherein at least one of the matching ones of the objects has a visibility state in the at least one active viewpoint in one of the first and the second scene graphs and an invisibility state in the at least one active viewpoint in the other one of the first and the second scene graphs.

40. The method of claim 34, wherein said identifying step comprises initially matching visible ones of the objects in the first and the second scene graphs, followed by matching remaining visible ones of the objects in the second scene graph to non-visible ones of the objects in the first scene graph, and followed by matching remaining visible ones of the objects in the first scene graph to non-visible ones of the objects in the second scene graph.

41. The method of claim 40, wherein said identifying step further comprises marking further remaining, non-matching visible ones of the objects in the first scene graph using a first index, marks further remaining, non-matching visible objects in the second scene graph using a second index.

42. The method of claim 41, wherein said identifying step further comprises ignoring or marking remaining, non-matching non-visible ones of the objects in the first and the second scene graphs using a third index.

43. The method of claim 34, wherein the timeline is a single timeline for all of the matching ones of the objects.

44. The method of claim 34, wherein the timeline is one of a plurality of timelines, each of the plurality of timelines corresponding to a respective one of the matching ones of the objects.
